(19) United States
(12) Patent Application Publication
(10) Pub. No.: US 2013/0072369 A1
(43) Pub. Date: Mar. 21, 2013

(54) CENTRIFUGAL SEPARATOR

(71) Applicant: Chuanzhong Zhang, Qinzhou City (CN)

(72) Inventor: Chuanzhong Zhang, Qinzhou City (CN)

(73) Assignee: Qinzhou AuraSource Technology Inc., Quinzhou City (CN)

(21) Appl. No.: 13/635,680

(22) PCT Filed: Mar. 14, 2011
(86) PCT No.: PCT/CN11/71757

§ 371 Date: Nov. 27, 2012

(30) Foreign Application Priority Data
Mar. 15, 2010 (CN) 201010123864.4

(51) Int. Cl. B04B 11/00

(52) U.S. Cl. CPC B04B 11/00
USPC 494/42

(57) ABSTRACT

A centrifugal separator includes a separation drum, a feed inlet, at least one heavy material outlet with a ring-shaped recess and at least one light material outlet. The feed inlet is located at the head of the separation drum. A feed accelerator is installed at the feed inlet. This feed accelerator cooperates with the proper form of the separation drum and the corresponding location of the material outlet to form a material differential rotation propulsion device. The material differential rotation propulsion device is capable of rotating the feed slurry material along with the separation drum in a slightly different rotation speed and forcing the processed materials to be discharged from separation drum via different outlets. The infeed flow rate is larger than or equal to the total sum of the outfeed flow rates of heavy and light materials so that the separation drum is full of materials during operation.

### TECHNICAL FIELD

The present invention relates to a centrifugal separation apparatus which applies to the separation of tiny particles in slurry based on density.

### BACKGROUND ART

There is one type of separator containing rotary bowl in current commercial separation apparatus that are used to separate slurry particles with different density. This type of separator was first public in Canada Patent CA1111809A1, and then was improved in a series of patents, such as U.S. Pat. No. 4,608,040, U.S. Pat. No. 4,846,781, U.S. Pat. No. 5,338,284, U.S. Pat. No. 5,462,513, U.S. Pat. No. 5,586,965, U.S. Pat. No. 5,601,523, U.S. Pat. No. 6,149,572, U.S. Pat. No. 6,796,934, US2004013260, US20050026766, US20060135338. This kind of separator is called Knelson or Falcon separator. The main structure of this separator includes a high speed rotary bowl and several recesses on the outer surface of the bowl. A feed duct goes into the bottom of the bowl. Vane wheel is installed at the bottom of the bowl to accelerate the slurry feed. In some patents, liquid injection devices are set up in the ring to avoid solid leftovers. Some other patents use throttling devices to keep heavy feed discharging from the bowl. Here is how it works. Slurry material goes into the rotary bowl through the vertical feed duct. Under 50-300 G gravitational force, particles stratify along the inner surface of the bowl based on different density. Heavy particles will concentrate at the bottom of the recess or discharge through the throttling devices to heavy particle outlet. Light particles will get out at the top of the rotary bowl to light particle outlet. The particle stratification is based on density and size of the particle. From the bottom to the top, the order is heavy small particle, heavy big particle, light small particle and light big particle. Due to the high relative speed of the slurry feed to inner surface of the rotary bowl or recess during the stratification, the stratified particles tend to mix up and this trend becomes more severe for smaller particles. As a result, this type of separator is ineffective to remove ash or sulfur when the coal particles are very small. In report, the minimum effective separation size is 37 microns and particles smaller than this size are unable to be separated.

### SUMMARY OF THE INVENTION

The object of the present invention is to provide a centrifugal separation apparatus based on stratification effect. This centrifugal separation apparatus is able to separate much finer particles without increasing rotary speed.

The present invention relates to a centrifugal separation apparatus which can be used to separate slurry particles based on density. It comprises a separation drum, a feed inlet, at least one heavy material outlet with a ring-shaped recess and at least one light material outlet. The separation drum is an annular chamber formed by an outer shell and an inner surface. It rotates about its drive shaft under external power. The annular chamber comprises a head and a tail. The feed inlet is located at the head of the separation drum. Light material outlet is located at the intersection of outer shell and inner surface or nearby inner surface of the tail. Heavy material outlet is located through the recess at the outer shell of the tail. A feed accelerator is installed at the feed inlet. This feed accelerator cooperates with the proper form of the separation drum and the corresponding location of the material outlet to form a material differential rotation propulsion device. The material differential rotation propulsion device is capable of rotating the feed slurry material along with the separation drum in a different rotation speed and forcing the processed materials to be discharged from separation drum via different outlets. The infeed flow rate is larger than or equal to the total sum of the outfeed flow rates of heavy and light materials so that the separation drum is full of materials during operation.

In one example, the material differential rotation propulsion device is designed in approximate hollow truncated cone shape with narrow head and wide tail, the feed accelerator comprises several radial plates mounted on the drive shaft, the radial plates are extended no wider than the inner surface of the separation drum, the distance between inner edge of light material outlet and the drive shaft is larger than the distance between outer edge of feed net and the drive shaft.

In another example, the material differential rotation propulsion device is designed in approximate hollow truncated cone shape with wide head and narrow tail. The feed accelerator is a turbine that has outlet facing the rotary direction of the bowl. Or the material differential rotation propulsion device is designed in approximate hollow truncated cone shape with narrow head and wide tail. The feed accelerator is a turbine that has an outlet facing the opposite rotary direction of the bowl. Or the material differential rotation propulsion device is designed in approximate hollow truncated cone shape with wide head and narrow tail. The feed accelerator comprises several radial plates. The distance between inner edge of light material outlet and the drive shaft is larger than the distance between outer edge of feed net and the drive shaft.

Ideally, there are several light material outlets and heavy material outlets which are symmetrically spaced along the bowl. Throttling device can be installed on the light and heavy material outlets. It can be controlled in real time by a magnetic device.

In addition, several vibrating stripes can be mounted on the outer sidewall of the separation drum and vibrating stripes project inwardly and extend longitudinally. A ring-shaped heavy material buffering chamber can be disposed between the ring shape recess and heavy material outlets. The heavy material buffering chamber is communicated with the ring shape recess via a narrow gap. Moreover, the ring shape recess is provided with a thin decelerating ring which can be fixed on the sidewall of the recess via a crossbeam. The decelerating ring can be corrugated.

One or more sets of intermediate material outlets can be installed between the heavy material outlets and the light material outlets. Light material outlets can be installed on the inner sidewall of the separation drum. Or a ring shape light material buffering chamber can be installed at the light material outlets.

The centrifugal separation apparatus described in this invention rotates the slurry material along with the separation drum, maintains a speed difference between the slurry material and the separation drum, and discharges different density materials from corresponding outlets. This apparatus utilizes stratification effect. It is able to efficiently separate finer slurry particles without increasing the rotational speed.

### DESCRIPTION OF THE DRAWINGS

FIG. 1 is a cross-sectional view of the main structure of the centrifugal separation apparatus according to the present invention;

FIG. 24 are cross-sectional views of the centrifugal separation apparatus with different material differential rotation propulsion devices;

FIG. 5 is a cross-sectional view of the centrifugal separation apparatus in which slurry material moves upward;

FIG. 6 is a 3D view of the turbine with outlet facing the rotary direction of the separation drum in which parts of turbine case is removed;

FIG. 7 is a 3D view of the turbine with outlet facing the opposite rotary direction of the separation drum in which parts of turbine case is removed;

FIG. 8 is a cross-sectional view of an example of the centrifugal separation apparatus according to the present invention, in which an outer cover of the centrifugal separation apparatus is omitted;

FIGS. 9-11 are cross-sectional views of the throttling device under full close, partial open and full open condition;

FIG. 12 is a cross-sectional view of the separation drum with vibrating stripes mounted on its outer sidewall;

FIG. 13 is a cross-sectional view of the separation drum with vibrating stripes mounted on its outer sidewall along C-C′ as shown in FIG. 12;

FIG. 14 is a cross-sectional view of the separation drum with ring shape heavy material buffering chamber installed between the recess and heavy particle outlet;

FIG. 15 is a cross-sectional view of the separation drum with thin decelerating ring disposed in the recess;

FIG. 16 is a partially enlarged view of the thin decelerating ring as shown in FIG. 15;

FIG. 17 is a cross-sectional view of the separation drum with intermediate particle outlet; and

FIG. 18 is a cross-sectional view of the separation drum with buffering chamber installed at the light material outlet.

### PREFERABLE MODE OF CARRYING OUT THE INVENTION

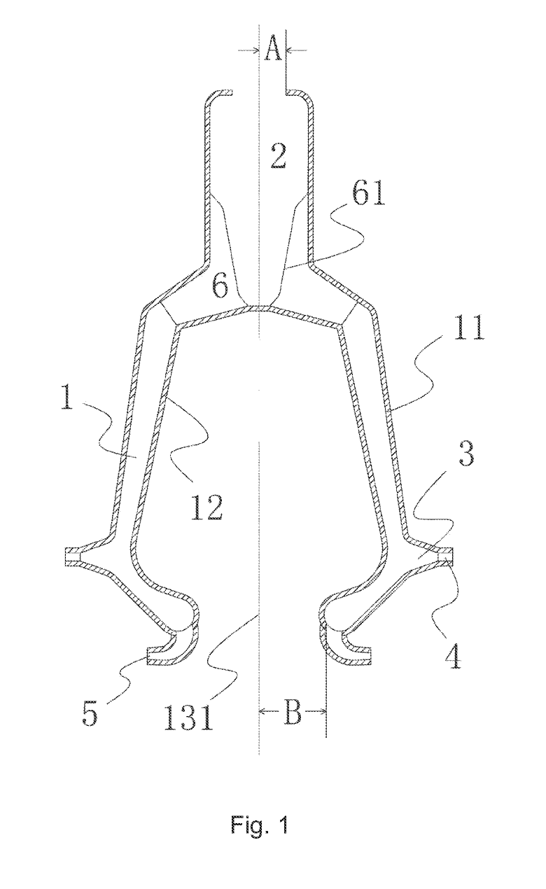

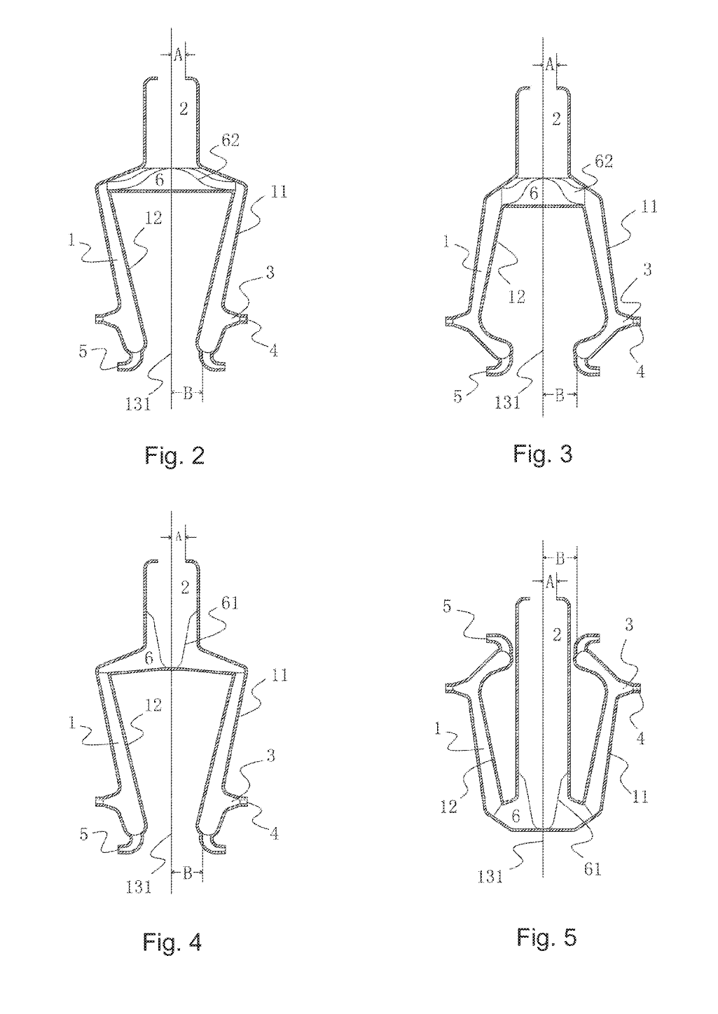

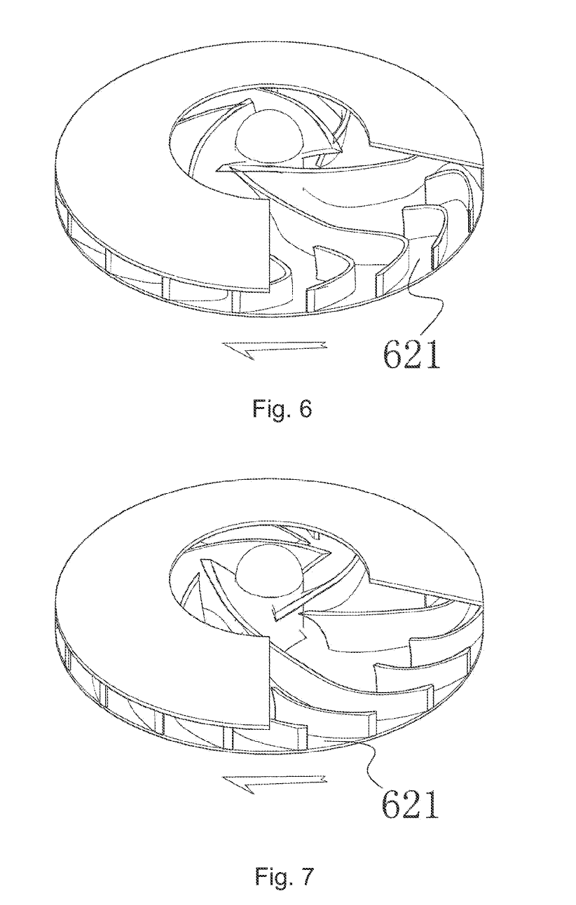

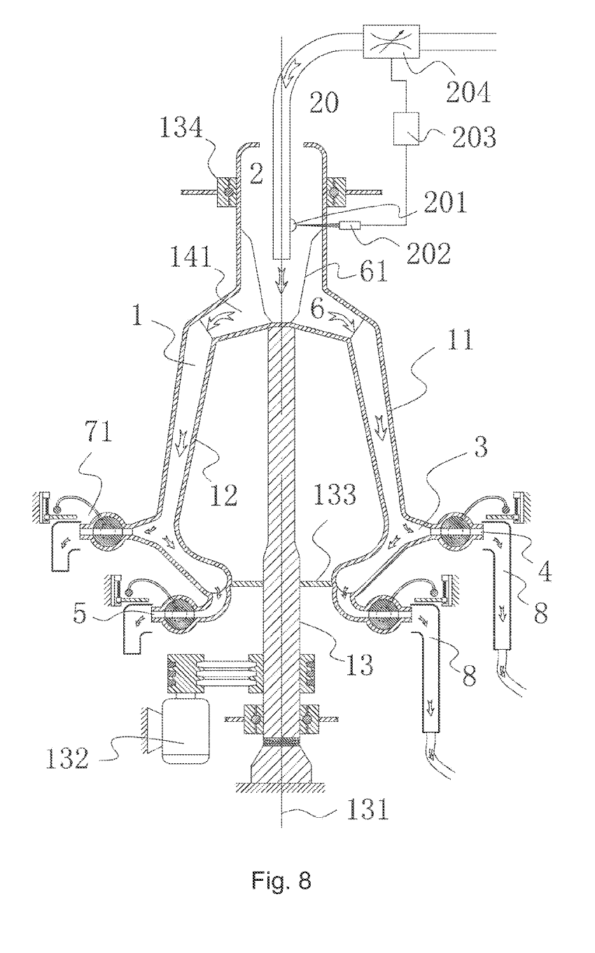

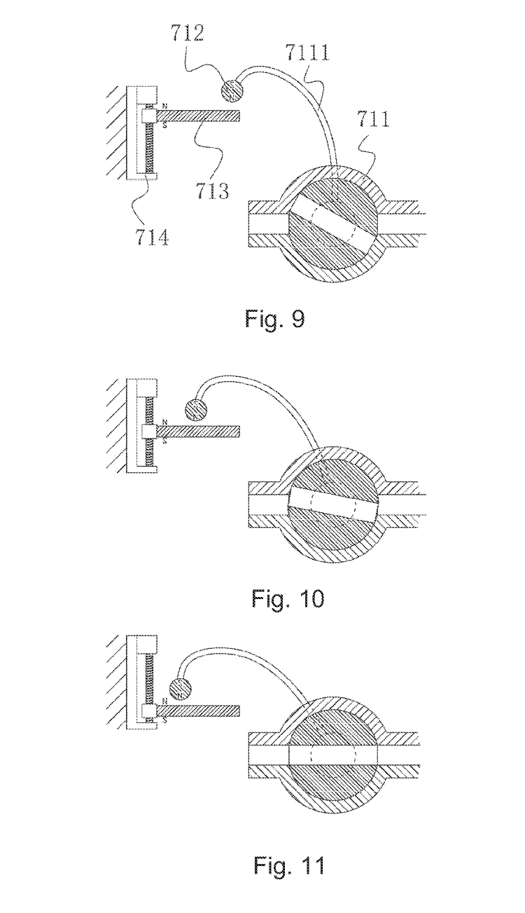

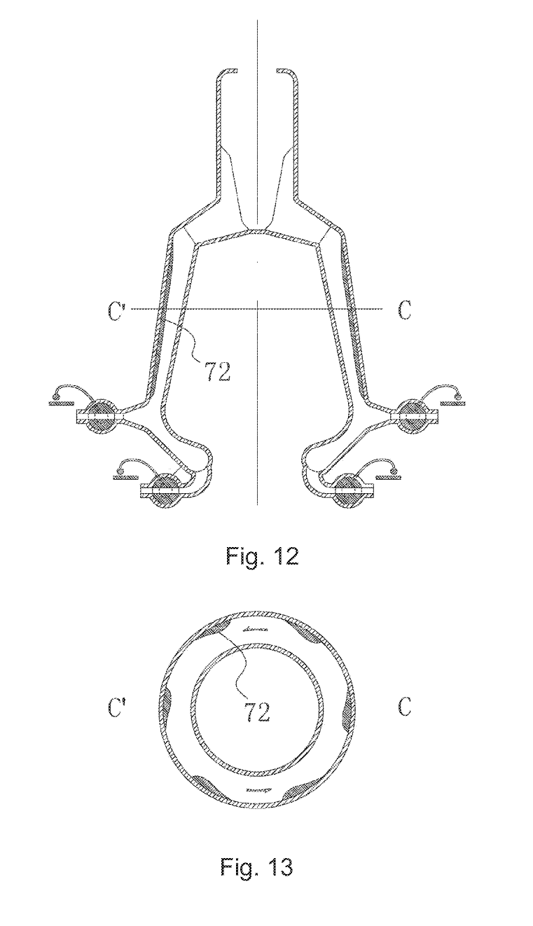

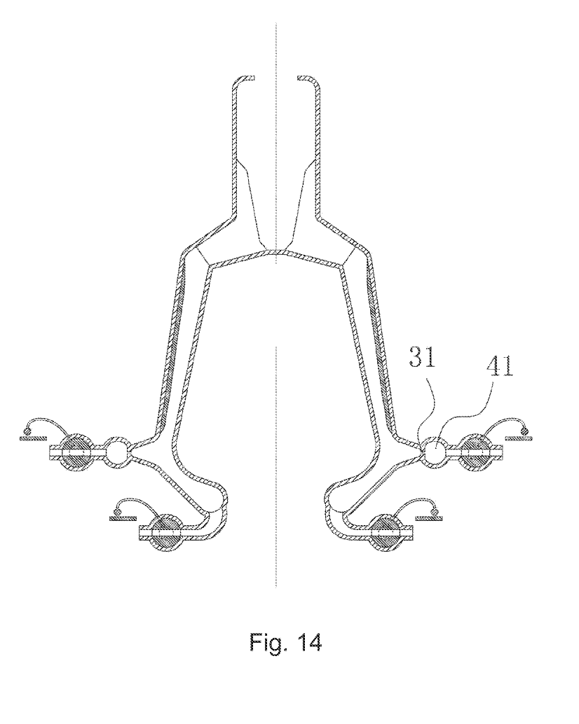

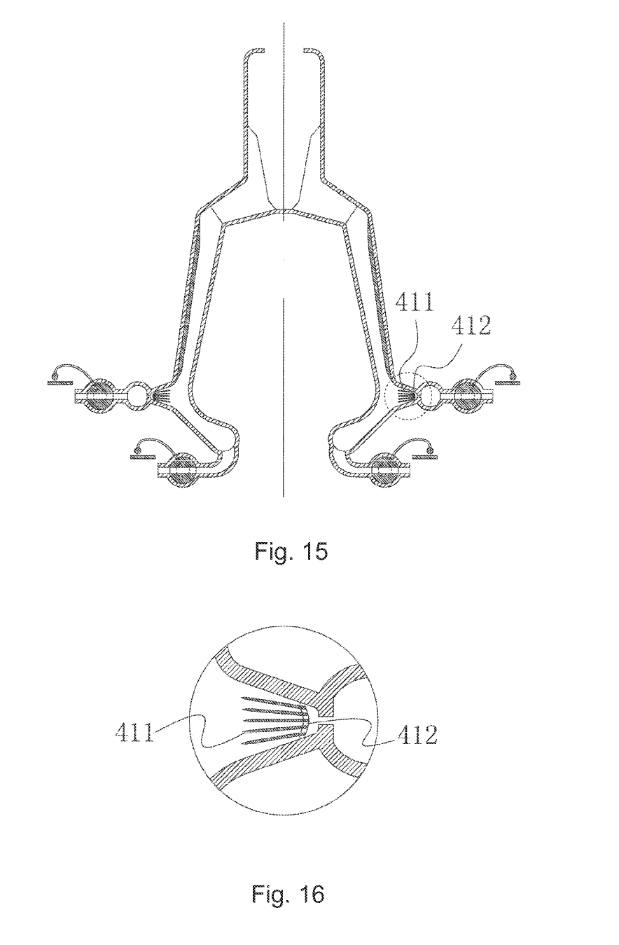

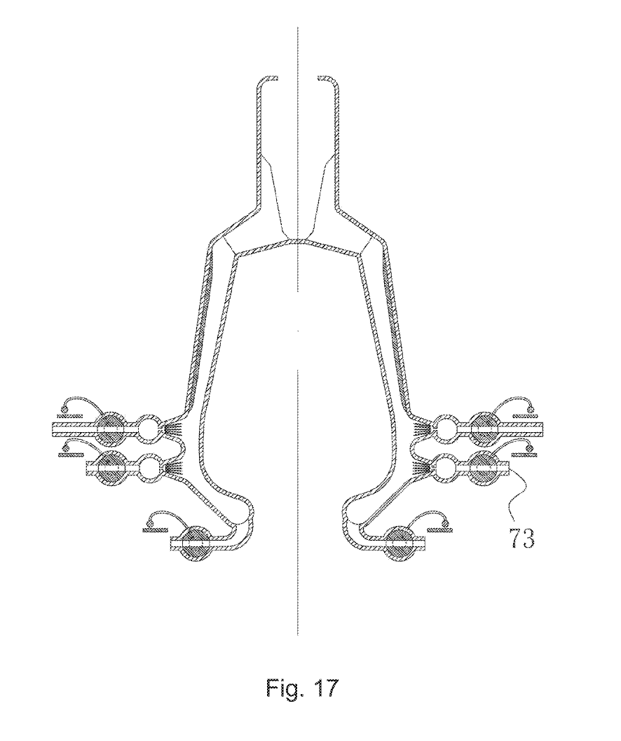

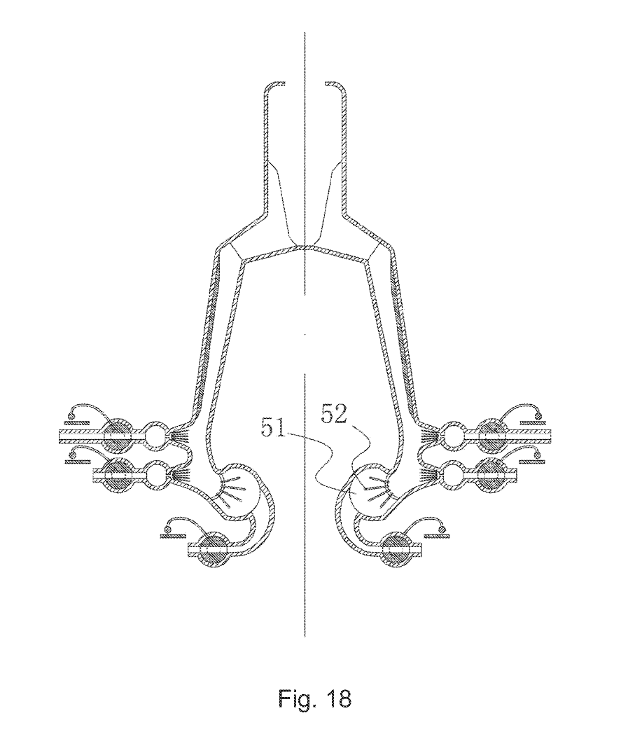

As shown in FIG. 1, the centrifugal separation apparatus comprises a separation drum 1, feed inlet 2, at least one heavy material outlet 4 with ring shape recess and at least one light material outlet 5. The separation drum 1 is an annular chamber formed by an outer shell 11 and an inner surface 12. It rotates along its drive shaft 131 under external power. The separation drum 1 comprises a head 14 and a tail 15. The feed inlet 2 is connected to the separation drum 1 through the channel between inner surface 12 and outer shell 11. Light material outlet 5 is located at the intersection of outer shell and inner surface or nearby inner surface of the tail. Heavy material outlet 4 is located through the recess 3 at the outer shell of the tail. A feed accelerator 6 is installed at the feed inlet 2. The feed accelerator 6 cooperates with the proper form of the separation drum 1 and the proper location of the material outlet composes a material differential rotation propulsion device. The material differential rotation propulsion device is capable of making the feed slurry material rotate along with the separation drum 1 in a proper difference rotation speed and forcing the processed materials discharge from separation drum by way of different outlets. The inlet feed flow rate should be larger than or equal to the total of heavy and light materials outlet flow rate so that the separation drum is full of material during operation.

In one example, the material differential rotation propulsion device is designed that the separation drum 1 is approximate hollow truncated cone shape with narrow head and wide tail, the feed accelerator 6 comprises several radial plates 61 mounted on the drive shaft, the radial plates are extended no wider than the inner surface of the separation drum 1, the distance B between inner edge of light material outlet and the drive shaft is larger than the distance A between outer edge of feed inlet and the drive shaft. The center plane of plates 61 passes the axis of drive shaft, and the plates 61 conjoint with the inner surface and the outer shell of the separation drum 1.

In another example as shown in FIG. 2 and FIG. 6, the material differential rotation propulsion device is designed in approximate hollow truncated cone shape with wide head and narrow tail. The feed accelerator 6 is a turbine 62 that has outlet 621 facing the rotary direction of the separation drum 1 so that the rotational speed of the feed is higher than that of the separation drum 1. Whether the distance between inner edge of light material outlet 5 and the drive shaft shall be larger, equal or smaller than the distance between outer edge of feed inlet 2 and the drive shaft depends on the pressure increase produced by the turbine 62. If the pressure increase is high, then the distance between inner edge of light material outlet 5 and the drive shaft can be smaller than the distance between outer edge of feed inlet 2 and the drive shaft.

In another example as shown in FIG. 3 and FIG. 7, the material differential rotation propulsion device is designed in approximate hollow truncated cone shape with narrow head and wide tail. The feed accelerator 6 is a turbine 62 that has outlet 621 facing the opposite rotary direction of the bowl 1 so that the rotational speed of the feed is lower than that of the bowl. Whether the distance between inner edge of light material outlet 5 and the drive shaft shall be larger, equal or smaller than the distance between outer edge of feed net 2 and the drive shaft depends on the pressure increase produced by the turbine 62.

As shown in FIG. 4, the material differential rotation propulsion device is designed in approximate hollow truncated cone shape with wide head and narrow tail. The feed accelerator 6 comprises several radial plates 61 mounted on the drive shaft. The distance between inner edge of light material outlet and the drive shaft is larger than the distance between outer edge of feed net and the drive shaft so that enough driving force is generated to overcome the friction between the slurry and the separation drum and push the material out of the separation drum.

As shown in FIG. 5, drive shaft is placed vertically for the consideration of machine balance. The feed can either move downward or upward. So the head of the bowl and feed inlet can be set up either at the top or bottom of the bowl.

A further illustration of the invention is described below in combination of specific examples.

### Example 1

As shown in FIG. 8-FIG. 11, this example has the basic structure of the invention. The arrow in the drawings shows the feed flow direction. The centrifugal separation apparatus comprises a separation drum 1, feed inlet 2, one set of heavy material outlets 4 with ring shape recess and at least one set of light material outlets 5. The separation drum 1 is an annular chamber formed by an outer she 11 and an inner surface 12. It comprises a head 14 and a tail 15. The drive shaft 13 with power unit 132 is fixed with inner surface 12 by connector 133. To enhance the stability of the separation drum while rotating, a support bearing can be installed between feed net 2 and machine cover. The feed net 2 is connected to the separation drum 1 through the channel between inner surface 12 and outer shell 11. Light material outlet 5 is located at the intersection nearby inner surface of the tail. Heavy material outlet 4 is located through the recess 3 at the outer shell of the tail. Both light material outlets and heavy material outlets are symmetrically spaced along the separation drum. Several radial plates 61 are mounted with inner and outer surface of the separation drum around the feed inlet passage 141. The radial plates are extended no wider than the inner surface of the separation drum 1. The distance B between inner edge of light material outlet 5 and the drive shaft is larger than the distance A between outer edge of feed inlet 2 and the drive shaft. The setup of radial plates, separation drum shape of wide head and narrow tail, and the position of light material outlet composes the material differential rotation propulsion device. This feed accelerator rotates the feed slurry material along with the separation drum. The material differential rotation propulsion device is capable of rotating the feed slurry material along with the separation drum in a slight lower different rotation speed and forcing the processed materials to be discharged from separation drum via different outlets. An automatic adjustment system is set up in the feed inlet 2. The infeed flow rate should be larger than or equal to the total sum of the outfeed flow rates of heavy and light materials so that the separation drum is full of materials during operation. The automatic adjustment system 20 in the feed inlet 2 can be either an overflow system or a throttle control system. The throttle control system can use radiation source 201 and radiation inspector 202 to obtain the liquid level in the separation drum. Then the liquid level real time data is analyzed by an analyzer 203 to control the feed rate by a throttle valve 204.

During operation, the separation drum rotates along the drive shaft by external power device. Slurry with particles of different density flows into the separation drum through feed inlet. It is accelerated by radial plates. According to the law of conservation of kinetic energy, the rotation radius of the slurry enlarging, the linear velocity of the slurry retains the same, its angular velocity decreases. As a result, there is a velocity difference between the slurry and the separation drum. Adjusting the relevant parameters of the centrifugal separation apparatus, keep a slight velocity difference between the slurry and the wall of separation drum. This velocity difference and the strong centrifugal force make the slurry stratify. The high density solid particles precipitate collectively towards the outer shell. When the solid particles reach a certain concentration, the centrifugal motion of the solid particles is equal to the effect that the relative motion between the slurry and the drum disturbance the slurry and prevents the solid particles' precipitate. Lighter particles move towards the inner surface in the extrusion of high density particles. Thus, particles stratify within the separation drum according to their density. This process happens simultaneously with the movement of the slurry in the separation drum. When the stratified slurry particles move to the ring shape recess, heavy particles discharge through the heavy particle outlet and light particles move beyond the recess and discharge through the light particle outlet. Both products go to corresponding product receiver passage 8.

The particle outlets need to be small enough or inlet big enough so that the separation drum is full of slurry and particles have enough time to be fully separated. The difference radius of the narrow head and wide tail of the separation drum determines the velocity difference between the slurry and the separation drum. The bigger the difference radius between the head and the tail is, the larger the velocity difference. In addition, the feed flow rate determines the velocity difference between the slurry and the separation drum. The bigger the feed flow rate, the larger the velocity difference.

The distance between inner edge of light material outlet and the drive shaft shall be no shorter than the distance between outer edge of feed inlet and the drive shaft. In this way, the centrifugal force is able to push the movement of slurry in the separation drum. Otherwise, slurry may move very slowly or even stop.

In order to discharge light and heavy materials uniformly, several outlets are installed symmetrically along the separation drum.

In the simplified specifications, all the outlets use fixed diameters.

In this example, throttle devices are installed in heavy and light particle outlets to control discharge flow rate and proportion of heavy and light materials.

To control it in real time, throttle device such as that described in U.S. Pat. No. 6,149,572 can be used. A better option could be using throttle device controlled by magnetic device 71.

As shown in FIG. 9-FIG. 11, the magnetic throttle control device 71 comprises a moving magnet 712 mounted on the throttle valve 711 and an adjustable circular track 713. By adjusting the position of the circular track 713, the opening of throttle valve and the discharge flow rate can be controlled.

The main structure of magnetic throttle control device 71 is described as follows. The circular track 713 is mounted on the machine cover and can be adjusted by a ball screw 714. The moving magnet 712 is installed on a cantilever 7111 connected to the throttle valve. The moving magnet has the opposite magnetic pole as the circular track 713. The moving magnet 712 tends to close the throttle valve under the centrifugal force. On the other hand, it tends to open the throttle valve under the repulsion force between magnets. As a result, the throttle valve can be controlled by adjusting the position of the circular track 713.

As compared to the Keelson or Falcon separator, the separator in this invention is able to have deeper stratification and longer duration. It is also able to avoid the disturbance which could damage the existing stratification. Thus, this separator is able to separate much smaller particles and improve the accuracy of separation.

### Example 2

As shown in FIG. 12-FIG. 13, based on example 1, several vertically extended vibrating stripes 72 are mounted on the outer shell of the separation drum to enhance the stratification process. The stripe extends from the radial plates near the feed inlet to the ring shape recess. The contour of the stripe cross section is similar to that of the upper part of airplane wing. The stripes apply vibrations to the slurry and enhance stratification without damage existing stratification.

### Example 3

As shown in FIG. 14, based on example 1, a buffering chamber 41 is set up between the recess and heavy particle outlet to discharge heavy particles more uniformly. The buffering chamber is connected to the ring shape recess through narrow gap 31.

Although there are several heavy particle outlets, the thickness of heavy particles is different near the outlet and away from the outlet. The discharged product could be a mixture of different density particles so that the accuracy of heavy particle is affected.

To solve this problem, a narrow gap 31 is set up at the bottom of the recess. Buffering chamber 41 is set up outside the narrow gap. The heavy particle outlet is located through the Buffering chamber 41.

Heavy particle slurry goes into the buffering chamber through the narrow gap. Then it rotates in the buffering chamber and flows out of the separation drum through the heavy particle outlets.

### Example 4

As shown in FIG. 15-FIG. 16, based on example 3, in order to reduce rotation speed of heavy particles in the recess and improve accuracy of separation, a thin decelerating ring 411 is installed on the recess surface by beam 412.

Slurry tends to accelerate because the sudden enlarging of the rotation radius as it enters the recess. This acceleration will harm the stratification process. To solve this problem, several thin decelerating rings 411 are installed in the recess. The decelerating ring separates the recess into multiple spaces and increases friction force of the slurry. In this way, it will decelerate the movement of the slurry in the recess and enhance the stratification. Decelerating rings are fixed by beam 412.

To further enhance the slurry stratification, corrugated ring can be used. It can cause horizontal vibrations for the slurry so that stratification effect can be enhanced.

### Example 5

As shown in FIG. 17, based on example 1, to improve the accuracy of separation, an intermediate particle outlet 73 is installed between heavy particle outlet and light particle outlet. Thus, there are three products in this example, i.e., heavy material, intermediate material and light material.

In operation, heavy particles concentrate in the recess near the heavy particle outlet and discharge. Other particles cross this area and enter the recess near the intermediate particle outlet. Intermediate particles concentrate and discharge from the intermediate particle outlet. Light particles cross this area and discharge from the light particle outlet.

### Example 6

As shown in FIG. 18, based on example 1, to purify the light material, the light particle outlet is set up on the inner surface of the separation drum. This configuration let the light slurry overcome the centrifugal force to discharge. And this process will further separate heavy particles from the slurry.

Based on this configuration, a buffering chamber 51 can be installed to further purify the light material. It is ring shape ball chamber which slows down the movement of the slurry. To make the movement of the slurry in the buffering chamber more uniform, a deflector 52 can be mounted in the buffering chamber 51.

All examples above only use one of four different separation drum configurations. The separation drum is designed in conical shape with narrow head and wide tail, the feed accelerator comprises several radial plates mounted on the drive shaft. Unless specified, all these examples are suitable for other configurations. They are not detailed here but these technical solutions shall also be protected by this patent.

The thin decelerating ring described in example 4 is not suitable for approximate hollow truncated cone shape separation drum with narrow head and wide tail. This configuration makes the rotational speed of slurry is higher than that of the separation drum and the decelerating ring will decrease even stop the movement of the slurry. As a result, the decelerating ring will not be used under this circumstance.

1-15. (canceled)

16. A centrifugal separation apparatus for separating slurry particles based on density, comprising a separation drum, a feed inlet, at least one heavy material outlet with a ring-shaped recess and at least one light material outlet; characterized in that said separation drum is an annular chamber formed by an outer shell and an inner surface; it rotates about its drive shaft under external power; the annular chamber comprises a head and a tail; the feed inlet is located at the head of the separation drum; light material outlet is located at the intersection of outer shell and inner surface or nearby inner surface of the tail; heavy material outlet is located through the recess at the outer shell of the tail; a feed accelerator is installed at the feed inlet; this feed accelerator cooperates with the proper form of the separation drum and the corresponding location of the material outlet to form a material differential rotation propulsion device; the material differential rotation propulsion device is capable of rotating the feed slurry material along with the separation drum in a different rotation speed and forcing the processed materials to be discharged from separation drum via different outlets; the infeed flow rate is larger than or equal to the total sum of the outfeed flow rate of heavy and light materials so that the separation drum is full of materials during operation.

17. The centrifugal separation apparatus as recited in claim 16, wherein said material differential rotation propulsion device is designed in approximate hollow truncated cone shape with narrow head and wide tail, the feed accelerator comprises several radial plates mounted on the drive shaft, the radial plates are extended no wider than the inner surface of the separation drum, the distance between inner edge of light material outlet and the drive shaft is larger than the distance between outer edge of feed inlet and the drive shaft.

18. The centrifugal separation apparatus as recited in claim 16, wherein said material differential rotation propulsion device is designed in approximate hollow truncated cone shape with wide head and narrow tail, the feed accelerator is a turbine that has an outlet facing the rotary direction of the separation drum.

19. The centrifugal separation apparatus as recited in claim 16, wherein said material differential rotation propulsion device is designed in approximate hollow truncated cone shape with narrow head and wide tail, the feed accelerator is a turbine that has an outlet facing the opposite rotary direction of the separation drum.

20. The centrifugal separation apparatus as recited in claim 16, wherein said material differential rotation propulsion device is designed in approximate hollow truncated cone shape with wide head and narrow tail, the feed accelerator comprises several radial plates, the distance between inner edge of light material outlet and the drive shaft is larger than the distance between outer edge of feed inlet and the drive shaft.

21. The centrifugal separation apparatus as recited in claim 16, wherein there are several light material outlets and heavy material outlets which are symmetrically spaced along the separation drum.

22. The centrifugal separation apparatus as recited in claim 21, wherein throttling devices are installed on the light material outlet and the heavy material outlet.

23. The centrifugal separation apparatus as recited in claim 22, wherein said throttling devices are controlled in real time by a magnetic device.

24. The centrifugal separation apparatus as recited in claim 16, wherein several vibrating stripes are mounted on the outer sidewall of the separation drum, and vibrating stripes project inwardly and extend longitudinally.

25. The centrifugal separation apparatus as recited in claim 24, wherein a ring-shaped heavy material buffering chamber is disposed between the ring shape recess and heavy material outlets, the heavy material buffering chamber is communicated with the ring shape recess via a narrow gap.

26. The centrifugal separation apparatus as recited in claim 25, wherein the ring shape recess is provided with a thin decelerating ring which is fixed on the sidewall of the recess via a crossbeam.

27. The centrifugal separation apparatus as recited in claim 26, wherein the decelerating ring is corrugated.

28. The centrifugal separation apparatus as recited in claim 27, wherein one or more sets of intermediate material outlets are installed between the heavy material outlets and the light material outlets.

29. The centrifugal separation apparatus as recited in claim 28, wherein the light material outlet is installed on the inner sidewall of the separation drum.

30. The centrifugal separation apparatus as recited in claim 27, wherein a ring shape light material buffering chamber is installed at the light material outlet.
